(19) United States
(12) Patent Application Publication
(10) Pub. No.: US 2007/0168434 A1
(43) Pub. Date: Jul. 19, 2007

(54) Email application smart paste entry feature

(76) Inventors: Jos Manuel Accapadi, Austin, TX (US); Andrew Dunshea, Austin, TX (US)

Correspondence Address: IBM CORP (YA);C/O YEE & ASSOCIATES PC, P.O. BOX 802333, DALLAS, TX, 75380, US

(21) Appl. No.: 11/334,676

(22) Filed: Jan. 18, 2006

(51) Int. Cl. G06F 15/16

(52) U.S. Cl. 709/206

(57) ABSTRACT

A computer implemented method, apparatus, and computer usable program code for saving information from an email message. The information is selected from the email message to form selected information. The selected information and header information is saved in the email message. The header information is designated through a user preference.

### BACKGROUND OF THE INVENTION

1. Field of the Invention

The present invention relates generally to an improved data processing system, and more particularly to a computer implemented method, apparatus, and computer usable program code for saving selected portions of emails.

2. Description of the Related Art

The Internet, also referred to as an “internetwork,” is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has revolutionized communications and commerce, as well as being a source of both information and entertainment. For many users, email is a widely used format to communicate over the Internet. Many users use email applications both commercially and personally for all types of communication. Email is particularly useful because of the ease of use and flexibility email offers.

Unfortunately, saving information from emails can be tedious and time consuming. Archiving whole emails is inefficient because the user may only want to store a small amount of information from an email anyway. Additionally, emails commonly include graphics, headers, signatures, and other text that may consume memory and disk space without providing value to the user.

Most users that want to save selected information from an email copy the specified information from the email application into a document that must be opened or found within a separate program. As a result, copying information between separate applications is inefficient and inconvenient.

### SUMMARY OF THE INVENTION

The present invention provides a computer implemented method, apparatus, and computer usable program code for saving information from an email message. Information is selected from the email message to form selected information. The selected information and header information is saved in the email message. The header information is designated through a user preference.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which aspects of the present invention may be implemented;

FIG. 2 is a block diagram of a data processing system in which aspects of the present invention may be implemented;

FIG. 3 is a block diagram of a data processing system in which aspects of the present invention may be implemented;

FIG. 4 is a block diagram of a data processing system in which aspects of the present invention may be implemented;

FIG. 5 is a diagram of a graphical user interface for presenting a user with options for setting smart paste preferences in accordance with an illustrative embodiment of the present invention;

FIG. 6 is a diagram of a graphical user interface for presenting a user with options for setting header preferences in accordance with an illustrative embodiment of the present invention;

FIG. 7 is a flowchart illustrating the operation of the smart paste application in accordance with an illustrative embodiment of the present invention;

FIG. 8 is a flowchart illustrating the operation of the smart paste application in accordance with an illustrative embodiment of the present invention;

FIG. 9 is a diagram of a graphical user interface for presenting a user with options for searching entries in accordance with an illustrative embodiment of the present invention;

FIG. 10 is a diagram of a graphical user interface for presenting smart paste entries in accordance with an illustrative embodiment of the present invention; and

FIG. 11 is a flowchart illustrating the searching feature of the smart paste application in accordance with an illustrative embodiment of the present invention.

### DETAILED DESCRIPTION OF THE PREFERRED EMBODIMENT

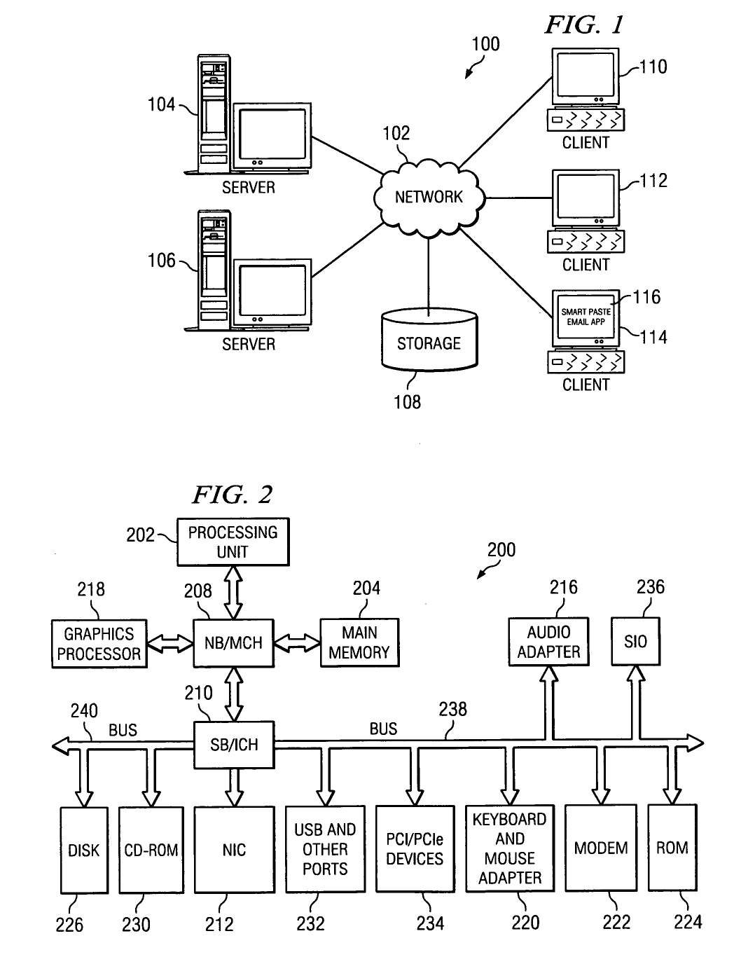

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages, such as email messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

Data processing systems are capable of communicating information to users in many formats, including, for example, text, graphics, sounds, animated graphics, synthesized speech, and video. The software distribution application employs a data processing system to combine such information formats into a coherent and comprehensive presentation to the users.

As a result of the increasing complexity of data processing systems and with the introduction of multimedia presentations, attempts have been made to simplify the interface between a user and the large amounts of data present within a modern data processing system. One example of an attempt to simplify the interface between a user and a data processing system is the utilization of so-called graphical user interface (GUI) 116 to provide an intuitive and graphical interface between the user, such as client 114 and the data processing system. Graphical user interface 116 is an interface system, including devices by which a user interacts with a system, system components, and/or system applications via windows or view ports, icons, menus, pointing devices, electronic pens, touch screens, and other input devices. Information may be both input and viewed by an administrative user and individual users using graphical user interface 116.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs, such as a smart paste email application, are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The different embodiments of the present invention provide a computer implemented method, apparatus, and computer usable program code for a smart paste email application for saving selected portions of emails. Embodiments of the present invention allow a user to save selected portions of an email message using a smart paste application so that the entire message does not need to be saved. The smart paste application allows only important information, herein referred to as the smart paste entry, to be stored. The smart paste email application may be an integrated portion of the email application or the smart paste email application may be an application that runs in conjunction with one or more email applications.

In one illustrative embodiment, the smart paste email application runs in the background and inserts an icon or option into the user's preferred email application. As a result, a user can easily use the smart paste feature from any email application or program installed on the user's data processing system. The user may establish various preferences for extracting information from an email message. For example, the selected information, or smart paste entry, may be saved to specified category. The category may be a folder, repository, document, spreadsheet, archive, mailbox, or other categorical storage point or electronic archive. In addition, the preferences may allow a user to associate keywords, labels, or subjects with the categories established for each type of information that may be archived.

The user preferences may also establish that the original message is automatically deleted once the selected information has been saved or extracted from the email message. The user preferences may also allow the user to select various automatic save features. For example, the user may select to automatically extract hyperlinks, images, text, attachments, contact information, and other information from the email message. As a result, various illustrative embodiments allow information to be manually and/or automatically extracted from the email message.

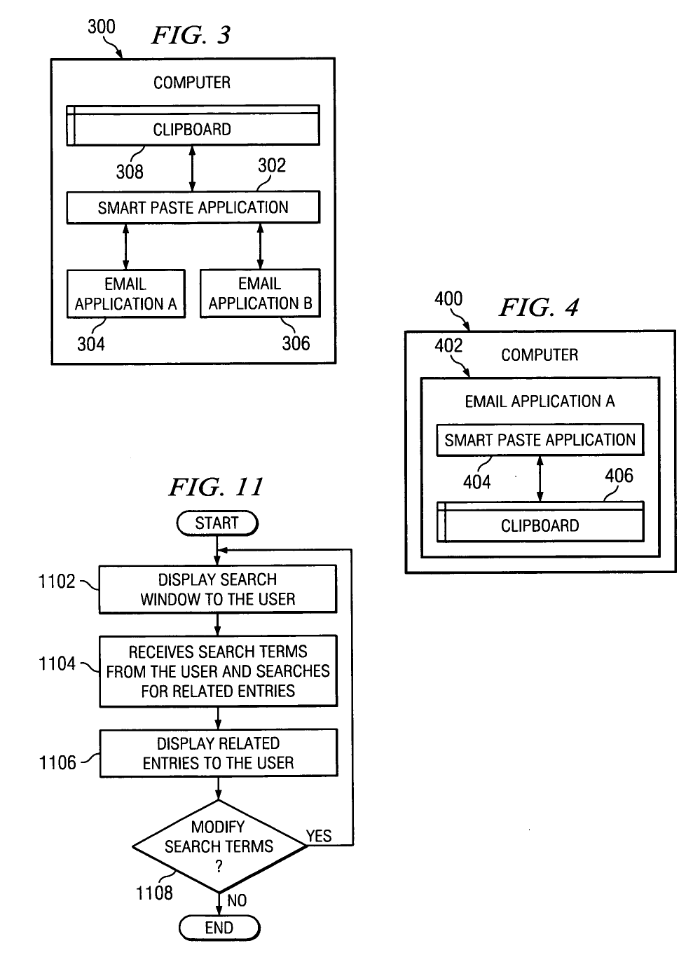

FIG. 3 is a block diagram of a data processing system in which aspects of the present invention may be implemented. Computer 300 is a computing device such as client 114 of FIG. 1. Computer 300 may execute various program applications, such as smart paste application 302, email application A 304, and email application B 306. Smart paste application 302 works in conjunction with email application A 304 and email application B 306.

In another embodiment, smart paste application 302 may be a smart paste feature that is an integrated clipboard function or notebook of the operating system. Additionally, an illustrative embodiment of the present invention may be a smart paste function integrated with an application or the operating system that may be used to extract important information from the operating system or any application. The user may access the smart paste function using an icon, menu, toolbar, shortcut, select key, or the smart paste function may automatically open when a data type is cut or copied from an application or the operating system.

In one example, a menu in email application A 304 may include an icon that allows a user to save selected information to a desired location. As a result, as the user is using email application A 304, the user selects specific information from the email message and archives the selected portions for later reference by using a mouse to click the integrated icon of smart paste application 302.

In another example, the user may select information from an email message in email application B 306 and then save the selected information to clipboard 308 using smart paste application 302. Clipboard 308 stores entries made using smart paste application 302. Clipboard 308 may be a buffer, section of memory, storage device such as a hard drive, or any other from of storage repository for storing data pasted into smart paste application 302. Once smart paste application 302 has been installed on computer 300, an icon, menu, toolbar, link, or other shortcut may be installed in email application A 304 and email application B 306 for allowing the features of smart paste application 302 to be easily accessed.

In another embodiment, the selected information may be later inserted into another program application. For example, the saved information may be pasted or inserted into a project such as a document, spreadsheet, or other filed used by another application. The saved information may then later be accessed by using the program application.

FIG. 4 is a block diagram of a data processing system in which aspects of the present invention may be implemented. Computer 400 is a computing device such as client 114 of FIG. 1. Computer 400 executes email application A 402 in which smart paste application 404 is integrated. In another embodiment, smart paste application 404 may be a feature of email application A 402 that similarly functions to allow a user to selectively save portions of an email message.

Smart paste application 404 may function as a integrated notepad, notebook, or multi-object clipboard that allows important information to be selectively saved to clipboard 406 without inefficiently archiving an entire email message. Smart paste application 404 may also be configured to automatically extract certain data types and information from the email message according to the user's preferences.

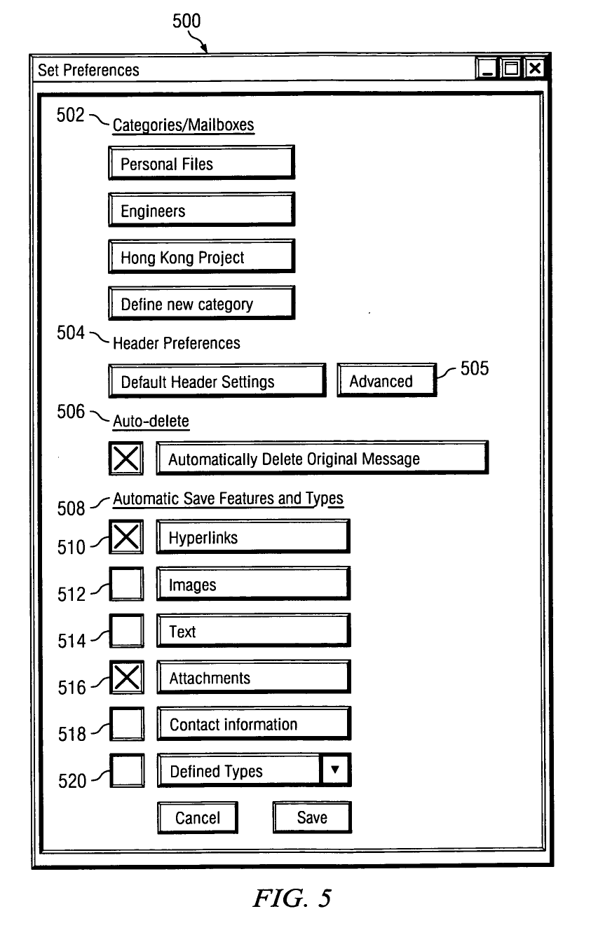

FIG. 5 is a diagram of a graphical user interface for presenting a user with options for setting smart paste preferences in accordance with an illustrative embodiment of the present invention. Window 500 illustrates an interface that is presented to a user for receiving user input regarding preferences. Window 500 may be displayed to a user on a graphical user interface, such as graphical user interface 116 of FIG. 1 in order to establish user preferences in a smart paste program such as smart paste application 404 of FIG. 4.

Window 500 may allow a user to establish categories 502, header preferences 504, set auto-delete 506 preferences, and set automatic save features 508. In window 500, the user may establish and define categories 502. Categories 502 are folders, mailboxes, divisions, documents, logs, entries, files, or other organized groups of information in which selected portions of an email message may be inserted or saved. For example, a user may create categories and sub-categories for personal email, work email, and any other topic or project needed to best organize information. For example, a user may use a category labeled schedule to insert upcoming due dates for easy reference and access.

Header preferences 504 establish what information is to be automatically extracted from the email message and inserted as a header to the newly created entry. For example, the header preferences may be used to remind the user of the content and context of the original message including information such as who the email was received from, when, and the original subject. The header is used to identify the initial email message. Optional header information may include email addresses, time and date, subject, carbon copy (CC), blind carbon copy (BCC), reply by, priority, contact information, and any other standard information that is sent or defined in the email message or email application.

A user may customize header preferences 504 as desired. For example, by selecting advanced control 505, the user may be displayed information for customizing the default header settings that are to be inserted in a smart paste entry. Advanced control 505 may be a icon, menu, hyperlink, or other graphical interface tool that displays another window or additional information to the user.

Auto-delete 506 allows a user to select whether the original email message should be deleted once selected information has been extracted from the email message. For example, if auto-delete 506 is selected, an original email message is deleted when the smart paste application is used to extract selected information from the original email message.

Automatic save features 508 establishes information and information types that are to be automatically extracted from an email message besides those portions selected by the user. Automatic save features 508 may allow a user to have the smart paste application extract information such as hyperlinks 510, images 512, text 514, attachments 516, contact information 518, and other defined types 520. Automatic save features 508 allow a user to extract additional information and data types from each email message without further effort. For example, a user may have the smart paste application automatically extract all hyperlinks 510 that link the email message to other documents, servers, websites, or information and attachments 516. As a result, the user may be assured that hyperlinks 510 and attachments 516 are automatically removed without being actively selected.

Additionally, the user may customize automatic save features 508 by selecting other defined types 520 to be extracted. In an illustrative embodiment, the user may define different types for automatic save features 508 to extract from email messages.

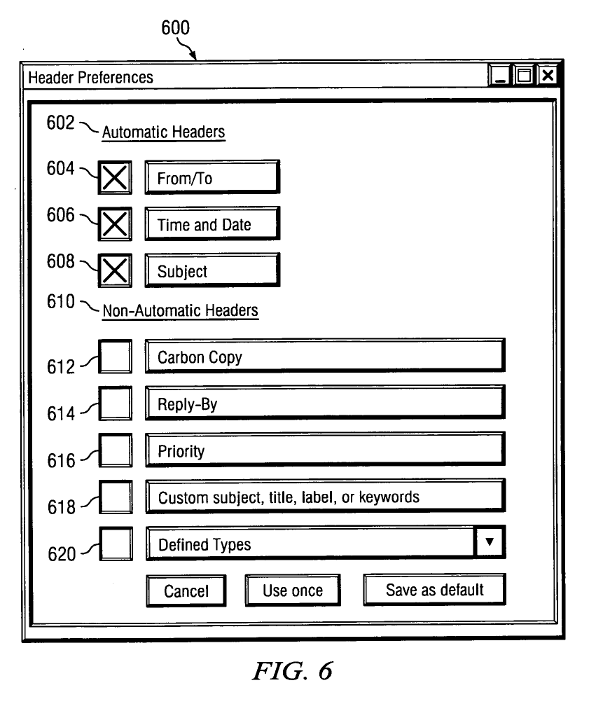

FIG. 6 is a diagram of a graphical user interface for presenting a user with options for setting header preferences in accordance with an illustrative embodiment of the present invention. Window 600 illustrates an interface that is presented to a user for receiving user input regarding header preferences that may be reached by selecting an advanced control for headers such as advanced control 505 of FIG. 5. Window 600 may be displayed to a user on a graphical user interface, such as graphical user interface 116 of FIG. 1 in order to establish user preferences in a smart paste program such as smart paste application 404 of FIG. 4. Window 600 may be displayed to a user when the user elects to set header preferences, such as header preferences 504 of FIG. 5.

Window 600 may allow a user to establish which information is automatically added as a header to the selected portions of the email message that are extracted. Automatic headers 602 may include email addresses such as from/to 604, time and date 606, and subject 608 of the original message. The user may also select non-automatic headers 610, such as carbon copy 612, reply-by 614, priority 616, label 618, and defined types 620. Automatic headers 602 and non-automatic headers 610 allow a user to choose information from the header that is typically included in an email message in order to ensure that the saved portions are distinguishable from other email messages.

The header provides a user-limited summary of the details of the original message. The user may select label 618 which allows the user to associate a custom subject, title, number, name, label, or keyword to be associated with the smart paste entry. For example, a user that has just received new contact information including mailing address, phone numbers, and email address for a client, Jonathon Doe, may enter label 618 “Jonathon Doe contact information”. Label 618 allows the user to reference the information contained in the smart paste entry for easy recognition at a later time. Additionally, label 618 may be used to search among multiple smart paste entries to find specific information efficiently.

A user may also customize the header by selecting from defined types 620 that are also defined within the email application. Selections made in window 600 may be used for a single smart paste entry to be saved as the default header settings.

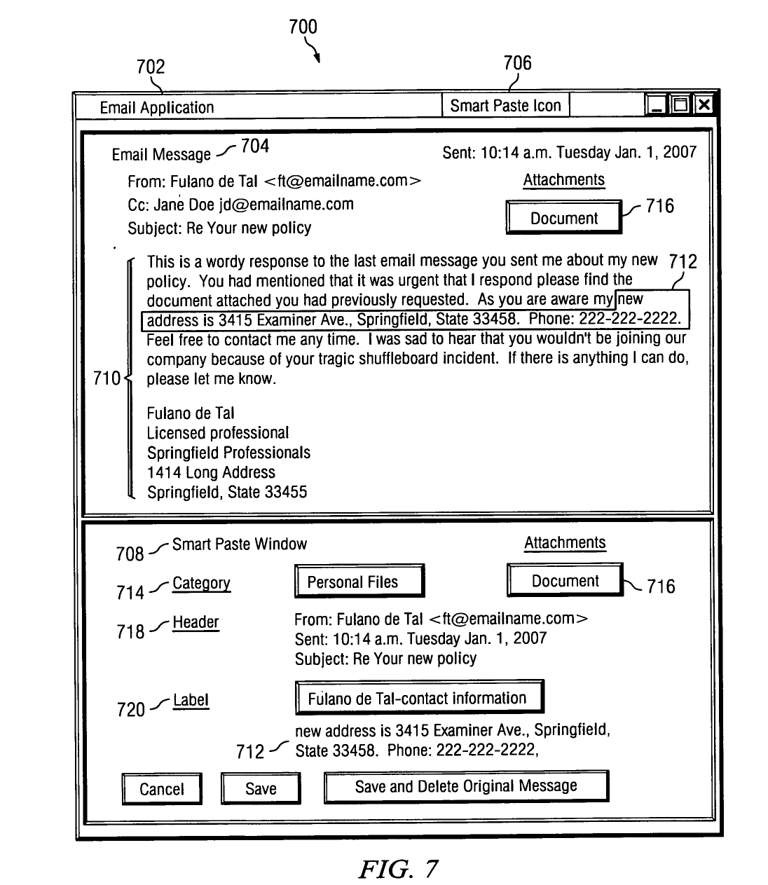

FIG. 7 is a diagram of a graphical user interface for using the smart paste application in accordance with an illustrative embodiment of the present invention. Window 700 illustrates an interface that is presented to a user for creating a smart paste entry in email application 702. Window 700 may be displayed to a user on a graphical user interface, such as graphical user interface 116 of FIG. 1 in order to create a smart paste entry in a program, such as smart paste application 404 of FIG. 4. Window 700 may be displayed to a user in email application 702, such as email application A 402 of FIG. 4 when the user wants to create a smart paste entry from selected portions of email message 704.

In one example, user has received email message 704 and wants to only save a portion of email message 704. User may use a mouse to click smart paste icon 706 in order to open smart paste window 708. Smart paste window 708 displays the information that is to be saved as a smart paste entry. Email message 704 may contain section of text 710 of which user only wants to save selected portion 712. Selected portion 712 is copied from email message 704 to smart paste window where selected portion 712 is inserted.

User may have already set preferences in a window such as window 500 of FIG. 5. User may choose category 714 in which smart paste entry is saved. For example, the user may decide that the email message contains personal information that is best saved in category 714 labeled personal files. User may have also selected to have attachments, such as document 716 automatically extracted into smart paste window 708.

Similarly, user may have already set header preferences in a window, such as window 600 of FIG. 6. As a result, header 718 is automatically inserted into smart paste window 708 to become part of the smart paste entry. Header 718 may detail who the email message is from as well as the sender's name, time and date sent, and original subject. Header 718 may also include label 720 so that the user may include keywords or a reminder of the information included in the smart paste entry. For example, label 720 may specify that the smart paste entry includes contact information.

The smart paste feature within email application 702 allows only relevant information, selected portion 712, to be efficiently stored. As a result, all of the miscellaneous information contained in email message 704 and section of text 710 does not need to be inefficiently saved. The user may elect to save the smart paste entry within the smart paste window with or without deleting the original message.

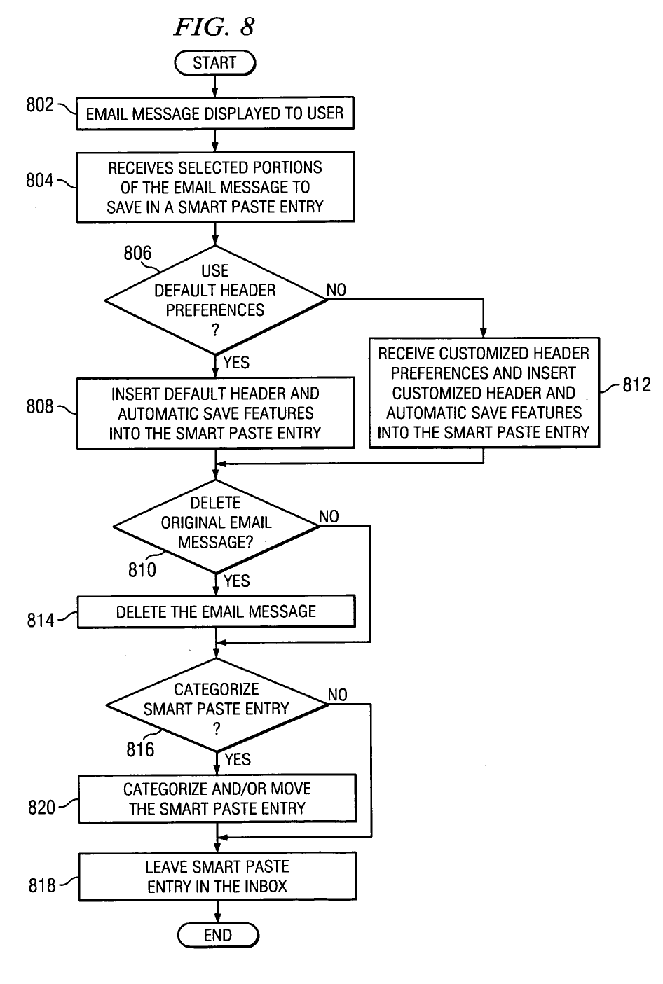

FIG. 8 is a flowchart illustrating the operation of the smart paste application in accordance with an illustrative embodiment of the present invention. The process of FIG. 8 may be implemented using a graphical user interface, such as graphical user interface 116 of FIG. 1 in a window of an email application including a smart paste window, such as window 700, email application 702, and smart paste window 708 of FIG. 7 respectively. The process begins by displaying an email message to the user (step 802). The user may be using an email application to graphically view the contents of the email message.

The user may decide that selected portions of the email message are important and should be saved without the rest of the message contained in the email. As a result, the process receives selected portions of the email message to save in a smart paste entry (step 804). The selection received in step 804 may be user input indicating which parts of the email message should be saved in a smart paste entry. A determination is then made as to whether the default header preferences should be used (step 806). The determination of step 806 is a decision to save selected portions of an email and is based on user input in this illustrative example.

If the user input is an election to use the default header preferences, the default header and automatic save features are inserted into the smart paste entry (step 808). The default header may be established by user input from window displayed on a graphical user interface, such as window 600 of FIG. 6. The save features may be determined based on user input, such as automatic save features 508 presented in a window, such as window 500 of FIG. 5. For example, the user may have indicated that all hyperlinks and attachments are to be automatically inserted into the smart paste entry.

The process continues as a determination is made as to whether to delete the original email message (step 810). In one embodiment, the determination of step 810 is based on user preferences for auto-delete selection, such as auto-delete 506 of FIG. 5. In another embodiment, the determination of step 810 is a decision based on user input. In an embodiment of the present invention, the original email message may not be deleted if minimal information is not included in the header. For example, the minimal information may include the sending or receiving email party, time, date, and subject.

Returning to the determination of step 806, if the user input is an election not to use the default header preferences, the process receives customized header preferences and inserts the customized header and automatic save features into the smart paste entry (step 812). The customized header preferences may be received from user input from window displayed on a graphical user interface, such as window 600 of FIG. 6. The customized header allows the user to determine what information is included in the smart paste entry in order to make the information more identifiable and useful to the user.

Returning again to the determination of step 810, if the user input is an election to delete the email message, the email message is deleted (step 814). As a result, the only record of the original email message is the smart paste entry.

A determination is then made as to whether to categorize the smart paste entry (step 816). Returning again to the determination of step 810, if the user input is an election to not delete the original email message, the determination is then made whether to categorize the smart paste entry (step 816). In one embodiment, the determination of step 816 is made from pre-established categories or mailboxes, such as categories 502 of FIG. 5. In another embodiment, the determination of step 816 is a decision based on user input. If the user input is an election not to categorize the smart paste entry in step 816, the smart paste entry is left in the inbox (step 818) with the process terminating thereafter. In an embodiment of the present invention, the smart paste entry which may be a truncated version of the original email message may not be deleted if minimal information is not included in the header. For example, the minimal information may include the sending or receiving email party, time, date, and original subject.

The smart paste application allows a smart paste entry to replace the original email message in order to more efficiently organize useful information. The truncated message in the form of a smart paste entry is a more abbreviated and efficient use of memory and resources.

If the user input is an election to categorize the smart paste entry in step 816, the smart paste entry is categorized and/or moved (step 820) with the process terminating thereafter. The smart paste entry may be categorized as selected by a user or based on user preferences from a category preference, such as categories 502 of FIG. 5. The use of different categories allows smart paste entries to be organized according to an individual user's needs. For example, a user may have three different categories for important types of messages including personal files, email messages from engineers, and messages regarding a Hong Kong project. As a result, the user can easily archive relevant information for later use. In an illustrative embodiment, the categories used in step 820 may be mailbox folders within the email application or separate categories for smart paste entries each of which may be stored or duplicated on different storage repositories, such as a local hard drive or a networked server.

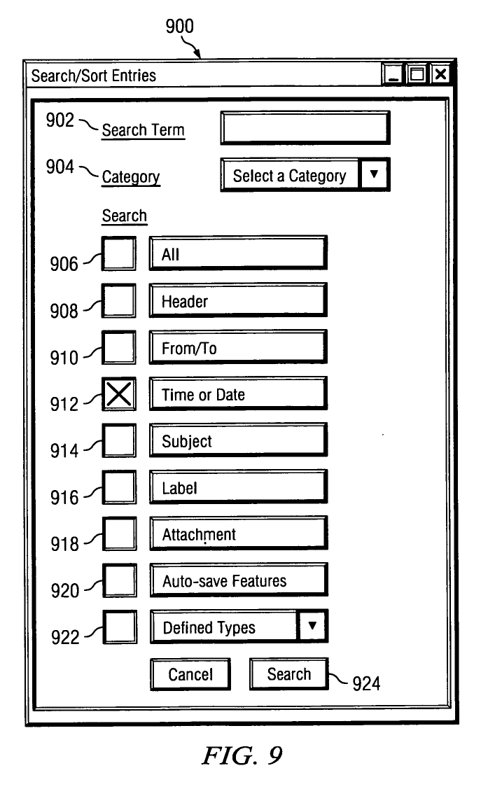

FIG. 9 is a diagram of a graphical user interface for presenting a user with options for searching entries in accordance with an illustrative embodiment of the present invention. Window 900 illustrates an interface that is presented to a user for receiving user input for searching or sorting entries in a smart paste application. Window 900 may be displayed to a user on a graphical user interface, such as graphical user interface 116 of FIG. 1 in order to set search options in a smart paste program, such as smart paste application 404 of FIG. 4.

Window 900 may allow a user to efficiently access previous smart paste entries. Search term 902 allows the user to enter and term, including words, numbers, or symbols that may identify a desired entry or entries. Additionally, the user may elect to display all entries within category 904 by selecting a specified category. By selecting category 904, the user can quickly view all entries that have been previously allocated to category 904. User may also organize entries within category 904 chronologically, by subject, by from/to, and by label in order to most effectively view the entries.

User may select what information, index, or data types within the entries are to be searched. For example, user may select to search all 906 information within each entry which includes all possible data saved by the smart paste application. In one embodiment, all 906 is the default index and a different index or indexes must be selected to specifically search only that index. The other indexes may include header 908, from/to 910, time or date 912, subject 914, label 916, attachment 918, auto-save features 920, and defined types 922.

Once the user has entered search term 902 and selected an index, the user may enter search button 924 to begin the search. Search button 924 may be an icon, button, hyperlink, or other graphical interface that begins the applicable search of the smart paste entries. Window 900 may be displayed to a user from the smart paste application, email application, operating system, or other program application. In one illustrative embodiment, search term 902 may be displayed on all of the graphical display windows displayed by smart paste application allowing a user to search and find information at any time.

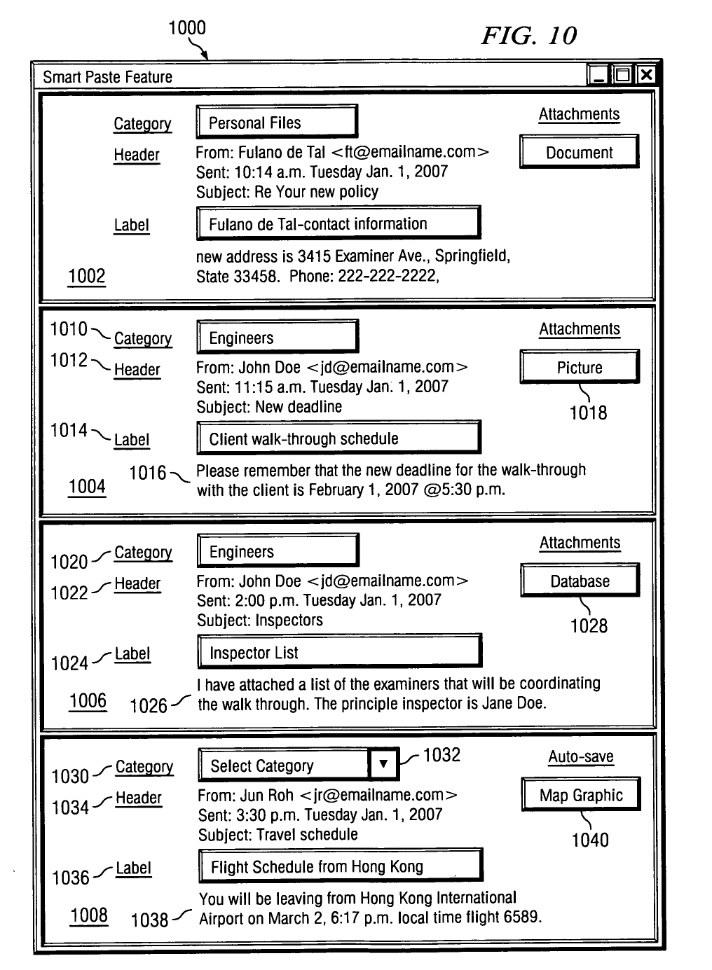

FIG. 10 is a diagram of a graphical user interface for presenting smart paste entries in accordance with an illustrative embodiment of the present invention. Window 1000 illustrates a window that is presented to a user for reviewing smart paste entires. Window 1000 may be displayed to a user on a graphical user interface, such as graphical user interface 116 of FIG. 1 in order to establish user preferences in a smart paste program, such as smart paste application 404 of FIG. 4. Window 1000 may be displayed to a user as the user pastes information into the smart paste feature or in response to a user selecting to search using a search button, such as search button 924 of FIG. 9. For example, a user that input the search term “Jan. 1, 2007” as the search term in the search window may get the four entries for the day.

Window 1000 includes four smart paste entries, entry 1002, entry 1004, entry 1006, and entry 1008. Entry 1002 is the entry made in a smart paste window, such as smart paste window 708 of FIG. 7. Entry 1004 is a second smart paste entry. The user has placed entry 1004 in engineers category 1010. Header 1012, automatically inserted into the smart paste entry, specifies that John Doe sent the message at 11:16 a.m. on Jan. 1, 2007 from an email account named jd@semailname.com and with the original subject line “new deadline”. User has specified label 1014 as “client walk-through schedule” based on selected portions 1016. Entry 1004 also includes picture 1018, which is an attachment. User may have selected to insert picture 1018 in entry 1004, or it may have been inserted automatically based on the automatic save preferences established by the user.

Entry 1006 is a third smart paste entry. The user has also placed entry 1006 in the engineers category 1020. Header 1022, automatically inserted into the smart paste entry, specifies that John Doe also sent the original message at 2:00 p.m. on Jan. 1, 2007 from an email account named jd@emailname.com and with the original subject line “inspectors”. User has specified label 1024 as “Inspector List” based on selected portions 1026. Entry 1006 also includes picture 1028, which is an attachment.

Entry 1008 is a fourth smart paste entry. The user has not yet placed entry 1008 in category 1030. User may use drop-down menu 1032 to select the desired location for entry 1008. Entries that are not designated a category may be assigned at a later time and stored in a default category. Header 1034, automatically inserted into the smart paste entry, specifies that Jun Roh sent the message at 3:30 p.m. on Jan. 1, 2007 from an email account named jr@emailname.com and with the original subject line “Travel Schedule”. User has specified label 1036 as “Flight Schedule from Hong Kong” based on selected portions 1038. Entry 1008 also includes map graphic 1040 which may be a graphic of a map to the airport included in the body of the original email message. Map graphic 1040 may have been inserted into entry 1008 automatically based on the automatic save preferences established by the user.

In an illustrative embodiment, entry 1008 may be a truncated version of the original email message that is left in the inbox. As a result, entry 1008 may be accessed in the inbox or categorized at a later time. Additionally, regardless of where entry 1008 is left or categorized, the user may mark or tag entry 1008 with an identifier, such as an icon, text, or graphic, that indicates that entry 1008 is a smart paste entry rather than the original email message.

FIG. 11 is a flowchart illustrating the searching feature of the smart paste application in accordance with an illustrative embodiment of the present invention. The process of FIG. 11 may be implemented using a graphical user interface, such as graphical user interface 116 of FIG. 1 in a window of a smart paste application such as smart paste application 404 of FIG. 4. The process begins by displaying a search window to the user (step 1102). The search window displayed in step 1102 may be in response to a user selecting to search smart paste entries by manipulating an icon, using a drop down menu, or otherwise indicating the need to search and may display search terms in a window, such as window 900 of FIG. 9.

Next, the process receives search terms from the user and searches for related entries (step 1104). The entries are searched based on the terms previously entered. The related entries are displayed to the user (step 1106). At this point, the user may read and sort the displayed entries as needed to extract the desired information. The user must determine whether the information sought was displayed in step 1106. A determination is then made as to whether to modify the search terms (step 1108). The determination of step 1108 is a decision to modify the search terms and is based on user input in this illustrative example.

If the user input is an election to modify the search terms, the process returns again to display the search window to the user (step 1102). If the user input is an election not to modify the search terms, the process terminates.

Embodiments of the present invention allow information to be extracted from an email message or other program and organized in categories for easy access at a later time. User preferences may be established so that information and data types are extracted from the original message, automatically allowing a user to quickly and efficiently access important information. As a result, less memory and disk storage space is required to save important information.

Illustrative embodiments of the present invention provide an efficient method of saving only the relevant portions of an email in a smart paste entry for efficiency. The user is able to delete extraneous information typically included in email messages while still retaining the most important aspects. The user may set preferences for categorizing the smart paste entries, automatically inserting a header for identifying the original email message, automatically deleting the original message once useful information is extracted, and automatically inserting information types into the smart paste entry. As a result, a user may quickly and more easily access important information without storing irrelevant data.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for saving information from an email message, the computer implemented method comprising:
selecting the information from the email message to form selected information; and
saving the selected information and header information in the email message, wherein the header information is designated through a user preference.

2. The computer implemented method of claim 1, wherein the selecting step comprises:
receiving user input selecting the information from the email message.

3. The computer implemented method of claim 1, wherein the selecting step comprises:
selecting the information based on the user preference.

4. The computer implemented method of claim 1, wherein the user preference establish automatic save features to automatically extract from the email message and insert in the selected information.

5. The computer implemented method of claim 4, wherein the automatic save features are any of hyperlinks, images, text, attachments, contact information, and defined types.

6. The computer implemented method of claim 1, wherein the saving step comprises:
saving the selected information along with the header information into a folder, wherein the header information and the folder is designated using the user preference.

7. The computer implemented method of claim 1, wherein the saving step further comprises:
responsive to receiving a request to delete the email message, truncating everything but the selected information and header information in the email message and leaving the selected information and header information saved where the email message had been.

8. The computer implemented method of claim 1, further comprising:
labeling the selected information and header information, wherein the label is a user description of the entry for identifying the entry and contents within the entry.

9. The computer implemented method of claim 1, wherein the header comprises any of an email address, time, date, subject, carbon copy, reply-by, priority, label and defined types.

10. The computer implemented method of claim 1, wherein the selecting step comprises:
receiving user input made by a user with an input device and a graphical user interface.

11. The computer implemented method of claim 1, further comprising:
creating a plurality of entries, wherein the plurality of entries each include selected information and header information extracted from each of a plurality of email messages;
searching a plurality of saved entries based on search terms; and
retrieving and sorting saved entries that correspond to the search terms and displaying the saved entries to the user.

12. The computer implemented method of claim 1, further comprising:
inserting the selected information and header information into another program application.

13. The computer implemented method of claim 1, further comprising:
displaying at least one window to the user for displaying the user preference.

14. A system comprising:
a processor and
a storage operably connected to the processor for storing an email application, wherein the email application is executed by the processor and wherein the email application allows a user to select information from an email message to form an entry, insert a header and automatic save features into the entry based on user preferences in response to the user selecting the information, and save the entry for later insertion into another application.

15. The system of claim 14, wherein the email application comprises a smart paste feature for creating and saving the entry in place of the email message.

16. The system of claim 14, wherein the folder is a user designated storage repository.

17. The system of claim 14, further comprising a smart paste application linked to the email application wherein the entry is created in the smart paste application from the email message.

18. A computer program product comprising:
a computer usable medium including computer usable program code for saving selected portions of an email message, the computer program product including:
computer usable program code for selecting information from the email message to form selected information;
computer usable program code for saving the selected information and header information in the email message, wherein the header information is designated through a user preference.

19. The computer program product of claim 18, further comprising:
computer usable program code responsive to receiving a request to delete the email message, for deleting the email message;
computer usable program code for saving the selected information and the header information in a folder;
computer usable program code for defining user preferences, wherein the user preferences define at least one folder, establish header preferences for indicating information to include in the header information, set auto-delete preferences, and establish automatic save features for specifying object types to automatically insert in the selected information.

20. A method for saving selected portions of an email message comprising:
receiving a user selection of information from the email message to form an entry;
defining a header for indicating information types to include in the header and for identifying the entry in response to receiving the user selection;
inserting the header and automatic save features into the entry, wherein the automatic save features specify information types that are to be automatically inserted into the entry based on user preferences;
responsive to receiving a request to delete the email message, for deleting the email message; and
saving the entry for later insertion into an application.
